(19) United States
(12) Patent Application Publication
(10) Pub. No.: US 2006/0126671 A1
(43) Pub. Date: Jun. 15, 2006

(54) Cycle time synchronization apparatus and method for wireless 1394 system

(76) Inventors: Seong Hee Park, Yuseong-Gu (KR); Sangsung Choi, Yuseong-Gu (KR); Kwang Roh Park, Seo-Gu (KR)

Correspondence Address: LADAS & PARRY LLP, 224 SOUTH MICHIGAN AVENUE, SUITE 1600, CHICAGO, IL, 60604, US

(21) Appl. No.: 11/260,591

(22) Filed: Oct. 27, 2005

(30) Foreign Application Priority Data
Dec. 15, 2004 (KR) 2004-106604

(51) Int. Cl. H04J 3/16; H04J 3/06

(52) U.S. Cl. 370/503; 370/469

(57) ABSTRACT

A cycle time synchronization apparatus for a wireless 1394 system having one wireless 1394 intermediary and at least one wireless 1394 slave, the apparatus including: a cycle time generator for generating a cycle time by a predetermined clock signal; a cycle time register synchronized to a beacon inputted, and storing the cycle time from the cycle time generator; a cycle time temporary storage unit for storing the cycle time of the cycle time register and cycle times generated from other devices; a cycle time management unit for managing calculation and control operations of the cycle times of the cycle time register and the cycle time temporary storage unit; and a cycle time controller for controlling the cycle time by the cycle time management unit.

### BACKGROUND OF THE INVENTION

1. Field of the Invention

The present invention relates to a cycle time synchronization apparatus and method for a wireless 1394 system, and more particularly, to a cycle time synchronization apparatus and method for a wireless 1394 system, for synchronizing a necessary cycle time to transmit isochronous data and asynchronous data between two or a plurality of wireless 1394 systems.

2. Description of the Related Art

In a conventional art, since IEEE1394 data transmission is performed in a wire network, not in a wireless network, there is not any drawback in synchronizing a cycle time between nodes, but in case where a transmission media is wireless, there is a drawback in accurately synchronizing the cycle time of each system due to the generation of error, the delay of transmission, and the request for retransmission when interconnection or data transmission is performed between two systems.

### SUMMARY OF THE INVENTION

Accordingly, the present invention is directed to a cycle time synchronization apparatus and method for a wireless 1394 system, which substantially obviates one or more problems due to limitations and disadvantages of the related art.

It is an object of the present invention to provide a cycle time synchronization apparatus and method for a wireless 1394 system, for transmitting a cycle time by a protocol where one wireless 1394 intermediary and a plurality of wireless 1394 slaves are mutually regulated, synchronizing the cycle time between two systems, and smoothly transmitting isochronous data and asynchronous data.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a cycle time synchronization apparatus for a wireless 1394 system having one wireless 1394 intermediary and at least one wireless 1394 slave, the apparatus including: a cycle time generator for generating a cycle time by a predetermined clock signal; a cycle time register synchronized to a beacon inputted, and storing the cycle time from the cycle time generator; a cycle time temporary storage unit for storing the cycle time of the cycle time register and cycle times generated from other devices; a cycle time management unit for managing calculation and control operations of the cycle times of the cycle time register and the cycle time temporary storage unit; and a cycle time controller for controlling the cycle time by the cycle time management unit.

In another aspect of the present invention, there is provided a cycle time synchronization method for a wireless 1394 intermediary having a physical layer, a MAC (media access control) layer, a PAL (protocol adaptation layer), and an application layer, the method including the steps of: in the PAL, requesting the MAC layer for a beacon generation, and confirming whether or not a beacon is transmitted; upon transmission of the beacon, in the PAL, requesting for a cycle time ASIE (application standard information element) generation, and confirming whether or not a beacon generation instruction is received from the MAC layer; and upon reception of the beacon generation instruction from the MAC layer, in the PAL, reading a cycle time from a second register, temporarily storing the read cycle time, and generating a cycle time ASE.

In a further another aspect of the present invention, there is provided a cycle time synchronization method for a wireless 1394 slave having a physical layer, a MAC (media access control) layer, a PAL (protocol adaptation layer), and an application layer, the method including the steps of in the PAL, requesting the MAC layer for a beacon reception confirmation, and confirming whether or not a beacon is received; upon reception of the beacon, confirming whether or not a beacon reception is instructed in the MAC layer; upon instruction of the beacon reception, in the PAL, reading a cycle time of a second register, and temporarily storing the read cycle time; in the PAL, receiving a cycle time ASIE from the MAC layer, calculating a drift of a slave cycle time at an intermediary cycle time generated from the same beacon number, and storing the calculated drift in the third register; and generating a signal of one clock cycle and enabling an event, to control the cycle time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a wireless 1394 system according to the present invention;

) FIG. 2 is a signal flowchart for a cycle time synchronization of a wireless 1394 intermediary and a wireless 1394 slave of FIG. 1;

FIG. 3 is a function block diagram illustrating a cycle time synchronization apparatus for a wireless 1394 system according to an embodiment of the present invention;

FIG. 4 is a diagram illustrating a buffer structure of a cycle time temporary storage unit of FIG. 3;

FIG. 5 is a detailed function block diagram illustrating a cycle time controller of FIG. 3;

FIG. 6 is a timing diagram illustrating a cycle time control signal of FIG. 5;

FIG. 7 is a detailed block diagram illustrating a cycle time generator and a cycle time register of FIG. 3;

FIG. 8 is a diagram illustrating a bit structure of the cycle time register of FIG. 7;

FIG. 9 is a flowchart illustrating a sequence of generating a cycle time in the cycle time generator of FIG. 3;

FIG. 10 is a signal flowchart illustrating a cycle time synchronization method for a wireless 1394 intermediary according to an embodiment of the present invention; and

FIG. 11 is a signal flowchart illustrating a cycle time synchronization method for a wireless 1394 slave according to an embodiment of the present invention.

### DETAILED DESCRIPTION OF THE INVENTION

Reference will now be made in detail to the preferred embodiments of the present invention, examples of which are illustrated in the accompanying drawings.

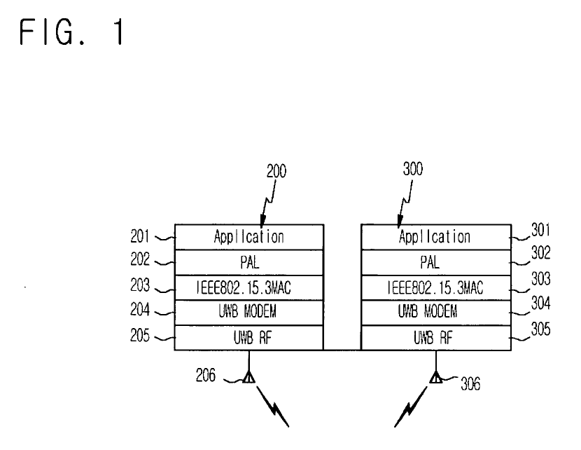

FIG. 1 illustrates a wireless 1394 system according to the present invention.

As shown in FIG. 1, the wireless 1394 system includes a wireless 1394 intermediary 200 and a wireless 1394 slave 300.

Each of the wireless 1394 intermediary 200 and the wireless 1394 slave 300 includes physical layers 205, 204 and 305, 304, media access control (MAC) layers 203 and 303, protocol adaptation layers (PALs) 202 and 302, and application layers 201 and 301.

Each of the physical layers 205, 204 and 305, 304 introduces an ultra wide band (UWB), and includes UWB radio frequencies (RF) 205 and 305, and UWB MOdulators/DEModulators (MODEM) 204 and 304. The MAC layers 203 and 303 introduce IEEE802.15.3 MAC, and introduce protocol adaptation layers 202 and 302 to allow the MAC layers and their lower regions to look like virtual IEEE1394. The PALs 202 and 302 are connected with the application layers 201 and 301, and transmit data of an IEEE1394 format.

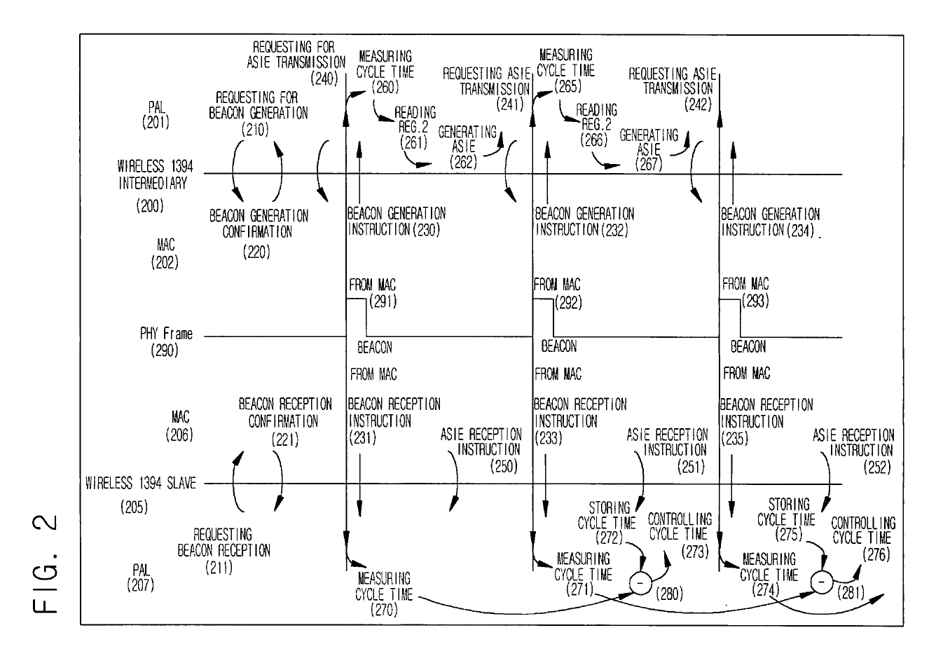

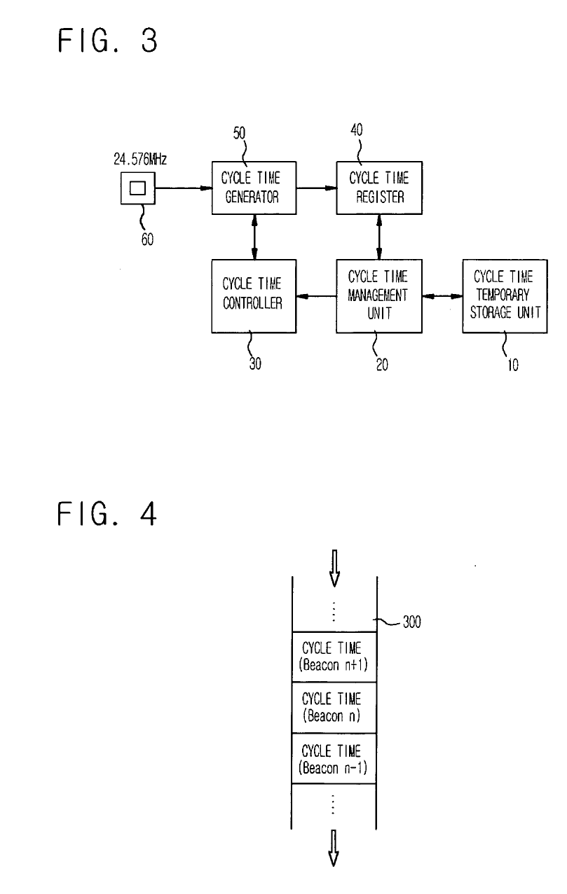

FIG. 3 is a function block diagram illustrating a cycle time synchronization apparatus for the wireless 1394 system according to an embodiment of the present invention.

As shown in FIG. 3, the inventive cycle time synchronization apparatus for the wireless 1394 system includes a cycle time generator 50 for generating a cycle time by a 24.576 MHz clock signal 60; a cycle time register 40 synchronized to an inputted beacon, and storing the cycle time from the cycle time generator 50; a cycle time temporary storage unit 10 for storing the cycle time of the cycle time register 40 and cycle times generated from other devices; a cycle time management unit 20 for managing calculation and control operations of the cycle times of the cycle time register 40 and the cycle time temporary storage unit 10; and a cycle time controller 30 for controlling the cycle time by the cycle time management unit 20.

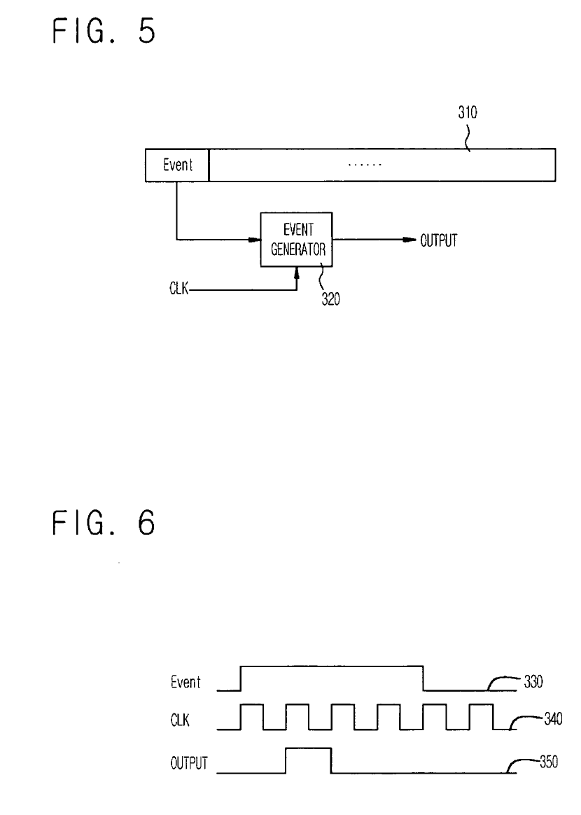

FIG. 5 is a detailed block diagram illustrating the cycle time controller of FIG. 3.

As shown in FIG. 5, the cycle time controller 30 includes a register 310 having an event bit; and an event generator 320 for synchronizing the event bit of the register 310 to a clock signal (CLK) 340 using the event bit of the register 310 as an event signal 330 of FIG. 6, and generating an output signal in one clock cycle 350.

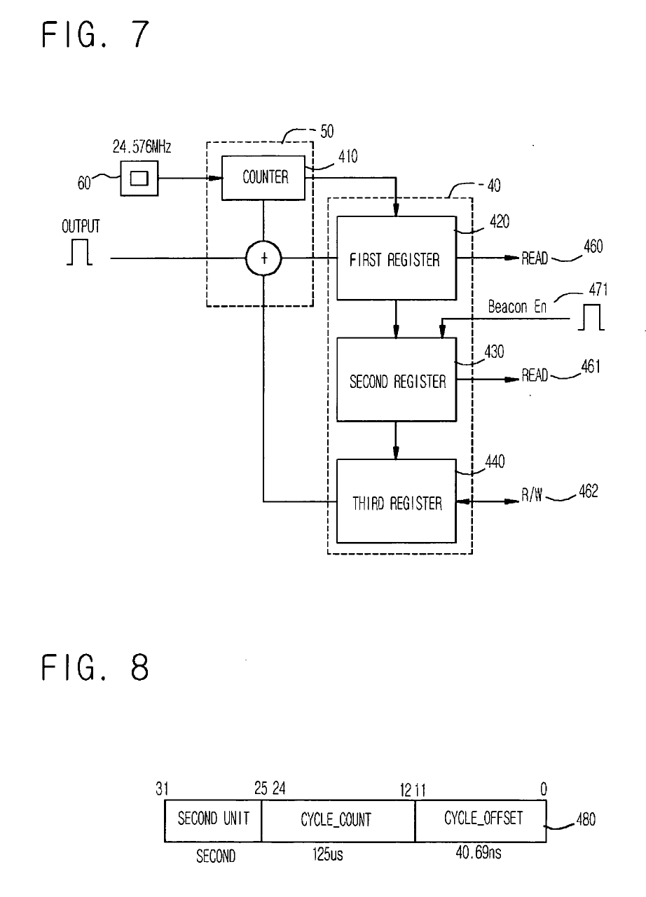

FIG. 7 is a detailed block diagram illustrating the cycle time generator and the cycle time register of FIG. 3.

As shown in FIG. 7, the cycle time generator 50 includes a counter 410 for receiving the 24.576 MHz clock signal 60, and counting 3,072 number of cycle_offset values, 8,000 number of cycle_count values, and seven bits of a second-unit count value; and an operation unit 450 for carrying out an operation of a current cycle time and a drift by the event signal of the cycle time controller 30, and controlling the value of the counter 410.

As shown in FIG. 7, the cycle time register 40 includes a first register 420 for storing the current cycle time from the cycle time generator 50; a second register 430 for storing the cycle time concurrently with generation of a beacon enable signal 471; and a third register 440 for storing the calculated drift.

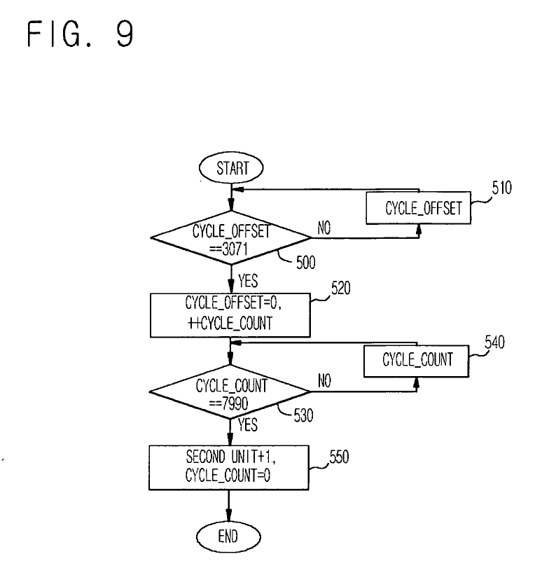

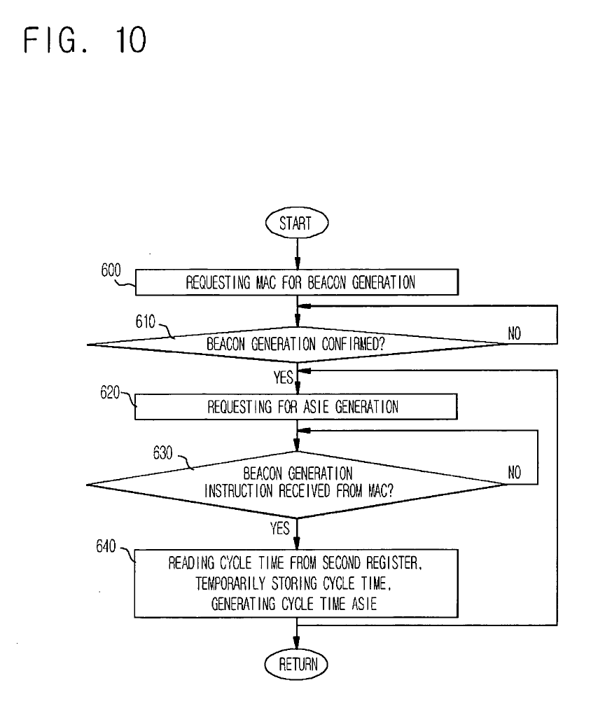

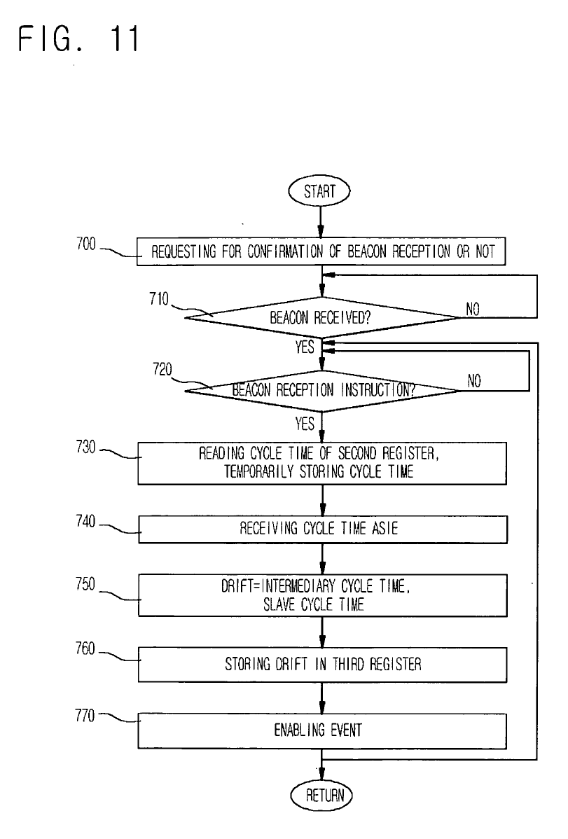

Then, an operation of the above-constructed cycle time synchronization apparatus for the wireless 1394 system according to an embodiment of the present invention will be in detail described with reference to FIGS. 2, 6, 8 and 9 to 11.

First, the counter 410 of the cycle time generator 50 receives the 24.576 MHz clock signal 60, and generates a 3.072 KHz cycle_offset 500 in a cycle of 40.69 ns, and an 8 KHz cycle_count 530 and a second unit value 550 in a cycle of 125 μs.

The cycle time generated from the counter 410 is synchronized to the 24.576 MHz clock signal 60, and is sequentially stored in the first register 420. In case of the stored cycle time, the current cycle time is stored in the second register 430 at a timing where the beacon enable signal 471 is enabled.

For the cycle time synchronization of the wireless 1394 intermediary 200 and the wireless 1394 slave 300, the PAL 202 of the wireless 1394 intermediary 200 requests the MAC layer 203 for beacon generation. (Step 600). The PAL 202 waits until receiving a beacon generation confirmation from the MAC layer 203 (Step 610).

The PAL 302 of the wireless 1394 slave 300 requests the MAC layer 303 for beacon reception, so as to request for a response as to whether the beacon reception or not (Step 700). The PAL 302 waits until receiving a beacon reception confirmation that is a predefinition that the MAC layer 303 informs the PAL 302 when the beacon is received (Step 710).

After the PAL 202 of the wireless 1394 intermediary 200 successfully receives the beacon generation confirmation, it constructs cycle time application standard information element (ASE) data and requests the MAC layer 203 for ASIE transmission, in order to transmit an actual cycle time to the wireless 1394 slave 300 (Step 620). When the beacon is generated, the MAC layer 203 informs the PAL 202 of a beacon generation instruction (Step 630). The PAL 202 measures and stores the cycle time in the second register 430, and generates an ASIE and requests for the ASIE transmission (Step 640). This process is repeatedly performed so that, whenever the beacon is generated, the wireless 1394 intermediary 200 transmits the cycle time value to the wireless 1394 slave 300.

After the PAL 302 of the wireless 1394 slave 300 successfully receives the beacon generation confirmation, the MAC layer 303 informs the PAL 302 of a beacon reception instruction (Step 720) when the beacon is received (Step 710). The PAL 302 measures and stores the cycle time in the second register 430 (Step 730). The stored data is stored in the cycle time temporary storage unit 10, and managed together with a beacon number. The PAL 302 receives an ASIE reception instruction from the MAC layer 303 (Step 740). After the beacon reception is requested, the first ASIE reception instruction is ignored. From the second beacon reception instruction, the cycle time value is extracted from the transmitted cycle time ASIE and stored in the cycle time temporary storage unit 10. A difference between the cycle times of the same beacon number is calculated (Step 750) and is stored in the third register 440 (Step 760), and the current cycle time is controlled (Step 273 of FIG. 2), and the cycle time synchronization is completed.

Meantime, in order to accurately control the cycle time, as shown in FIG. 5, the event bit of the register 310 is enabled and provided as an input signal of the event generator 320, and is synchronized to the clock signal (CLK) and the output signal (OUTPUT) of one cycle is generated as shown in the timing diagram of FIG. 6. The output signal of FIG. 5 is used as a signal for controlling the cycle time. The output signal (OUTPUT) presets the counter 410 to an operated value.

As described above, the inventive cycle time synchronization apparatus and method for the wireless 1394 system has an effective operation in, when the isochronous data and the asynchronous data are transmitted between the wireless 1394 intermediary and the wireless 1394 slave, accurately synchronizing the cycle time for determining effectiveness or not of the data transmission and reducing loss of the data transmission caused by inaccuracy of the cycle time.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A cycle time synchronization apparatus for a wireless 1394 system having one wireless 1394 intermediary and at least one wireless 1394 slave, the apparatus comprising:
a cycle time generator for generating a cycle time by a predetermined clock signal;
a cycle time register synchronized to a beacon inputted, and storing the cycle time from the cycle time generator;
a cycle time temporary storage unit for storing the cycle time of the cycle time register and cycle times generated from other devices;
a cycle time management unit for managing calculation and control operations of the cycle times of the cycle time register and the cycle time temporary storage unit; and
a cycle time controller for controlling the cycle time by the cycle time management unit.

2. The apparatus of claim 1, wherein the cycle time generator comprises:
a counter for receiving the clock signal, and counting a first predetermined number of cycle_offset values, a second predetermined number of cycle_count values, and seven bits of a second-unit count value; and
an operation unit for carrying out an operation of a current cycle time and a drift by an event signal of the cycle time controller, and controlling the value of the counter.

3. The apparatus of claim 1, wherein the cycle time register comprises:
a first register for storing the current cycle time from the cycle time generator;
a second register for storing the cycle time concurrently with generation of the beacon; and
a third register for storing calculated drift.

4. The apparatus of claim 1, wherein the cycle time controller comprises:
a register having an event bit; and
an event generator synchronized to the clock signal using the event bit of the register as an event signal, and generating an output signal in one clock cycle.

5. A cycle time synchronization method for a wireless 1394 intermediary having a physical layer, a MAC (media access control) layer, a PAL (protocol adaptation layer), and an application layer, the method comprising the steps of:
in the PAL, requesting the MAC layer for a beacon generation, and confirming whether or not a beacon is transmitted;
upon transmission of the beacon, in the PAL, requesting for a cycle time ASIE (application standard information element) generation, and confirming whether or not a beacon generation instruction is received from the MAC layer; and
upon reception of the beacon generation instruction from the MAC layer, in the PAL, reading a cycle time from a second register, temporarily storing the read cycle time, and generating a cycle time ASIE.

6. A cycle time synchronization method for a wireless 1394 slave having a physical layer, a MAC (media access control) layer, a PAL (protocol adaptation layer), and an application layer, the method comprising the steps of:
in the PAL, requesting the MAC layer for a beacon reception confirmation, and confirming whether or not a beacon is received;
upon reception of the beacon, confirming whether or not a beacon reception is instructed in the MAC layer;
upon instruction of the beacon reception, in the PAL, reading a cycle time of a second register, and temporarily storing the read cycle time;
in the PAL, receiving a cycle time ASIE from the MAC layer, calculating a drift of a slave cycle time at an intermediary cycle time generated from the same beacon number, and storing the calculated drift in the third register; and
generating a signal of one clock cycle and enabling an event, to control the cycle time.
